(19) United States
(12) Patent Application Publication
(10) Pub. No.: US 2011/0116756 A1
(43) Pub. Date: May 19, 2011

(54) OPTICAL COMPONENT ORGANISER

(75) Inventor: Kristof Vastmans, Boutersem (BE)

(73) Assignee: Tyco Electronics Raychem BVBA, Kessel-Lo (BE)

(21) Appl. No.: 12/737,346

(22) PCT Filed: Jun. 29, 2009
(86) PCT No.: PCT/GB2009/050751

§ 371 Date: Jan. 3, 2011

(30) Foreign Application Priority Data
Aug. 4, 2008 (GB) 0812271.5

(51) Int. Cl. G02B 6/46; G02B 6/44

(52) U.S. Cl. 385/135

(57) ABSTRACT

A reconfigurable passive optical component organiser (1) comprises a receiving surface (20,21,22) and restriction means (23,24,25,26,27). The receiving surface (20,21,22) comprises a plurality of relatively rigid regions hinged together and is reconfigurable between an open position and a closed position. In the open position the receiving surface (20,21,22) is configured to be substantially planar and retain a loop of optical fibre. In the closed position the receiving surface (20,21,21) is non-planar and substantially encloses said loop of fibre. The restriction means (23,24,25,26,27) act to prevent reconfiguration of the receiving surface (20,21,22) to the closed position bending the loop of fibre beyond the minimum bend radius of the loop of optical fibre.

### FIELD OF INVENTION

The present invention relates to an optical component organiser. In particular, the present invention relates to a reconfigurable optical component organiser for use with passive optical components.

### BACKGROUND OF THE INVENTION

Optical component organisers are known. For example, in an optical signal distribution system or network, such as that provided within a multiple dwelling unit (such as a building, or block of offices) which receives outside service provider cables from a provider, it is necessary to route the outside service provider cables to riser cables feeding individual dwelling units (such as apartments or offices) within the multiple dwelling unit.

The space available for the optical network or distribution system within the multiple dwelling unit (MDU) is typically particularly limited and as the number of outside service provider fibres increase (and given that these fibres may be split to enable the same outside service provider fibre to be coupled with more than one dwelling unit), the number of fibres to be managed within the same available space increases dramatically.

Whilst various optical component organisers exist, they each have their own shortfalls.

Accordingly, it is desired to provide an improved optical component organiser.

### SUMMARY OF THE INVENTION

One aspect of the present invention provides a reconfigurable passive optical component organiser comprising a receiving surface and restriction means, said receiving surface comprising a plurarlity of relatively rigid regions hinged together and being reconfigurable between an open position in which the receiving surface is configured to be substantially planar and retain the loop of optical fibre, and a closed position in which said receiving surface is non-planar and substantially encloses said loop of fibre, the restriction means acting to prevent the reconfiguration of the receiving surface to the closed position bending the loop of fibre beyond the minimum bend radius of the loop of optical fibre.

The passive optical component may be any component suitable for use in a passive optical network, for example, be a splice, a splitter or a multiplexer.

An end user may have various conflicting requirements with respect to a component organiser. In particular, to maintain propagation of a good optical signal along a fibre, such an organiser may house at least one full loop of a fibre. The extent of the organiser may therefore be dependent upon, amongst other things, the minimum bend radius of an optical fibre. Furthermore, installation of fibres within an organiser is simplified if the organiser is large enough to allow a user's hands to manipulate components and fibres easily and in which each significant element can be readily accessed. On the other hand, once elements have been installed within an organiser, it is often required to be as small as possible, to take up as little space within an optical system as possible. It can be seen that an organiser is simultaneously required to be both large and small.

Provision of an organiser which is reconfigurable allows the organiser to meet a first set of user requirements when in a first position and a second set of user requirements when in a second position. The user requirements in those first and second positions may, for example, as explained above, be contradictory.

In the open position, the receiving surface of a component organiser according to the present invention is substantially planar and thus all elements may be easily accessed by a user, thereby allowing maintenance and work on a loop of optical fibre retained thereon to be undertaken. In the open position in which the receiving surface is substantially planar, the majority of the loop of fibre may be easily accessed.

Although such an open substantially planar arrangement is convenient for the insertion and maintenance of a loop of optical fibre such an arrangement tends to be particularly demanding in terms of the surface area and volume it commands in an optical system. A component organiser that remains in a substantially planar configuration inefficiently consumes space within an optical system.

Once a user has inserted an optical fibre into the component organiser it is likely that no further disturbance of the loop of fibre within the component organiser will be required. It is therefore advantageous to be able to reconfigure the optical component organiser such that its footprint and the space it commands with in optical system is significantly reduced. Reconfiguration of the receiving surface such that it is non-planar enables such a reduction.

Substantially enclosing the loop of fibre with the receiving surface ensures that the fibre is protected in use against unexpected forces and against ambient environmental conditions, for example, dust. The receiving surface may therefore itself act as a housing.

Inclusion of restriction means ensures that the minimum bend radius of the loop of optical fibre is not exceeded when moving the receiving surface between the open position and the closed position. By using the minimum bend radius of the fibre as a limiting factor, the working area of the optical component organiser may be maximised in the open position, whilst minimising the useful space occupied by the component organiser when in the closed position.

Whilst advances in material technology are resulting in a reduction of the minimum bend radius of optical fibres, the size of an optical component organiser remains limited by a combination of the minimum bend radius of the optical fibre to be housed and the minimum size at which a user may still maintain and access fibres within a component organiser.

The receiving surface comprises a plurality of relatively rigid regions and a plurality hinged regions between adjacent relatively rigid regions. Such an arrangement allows a robust and resilient receiving surface to substantially enclose said loop of fibre. Such an arrangement thus allows good protection to the loop of fibre housed therein.

The receiving surface may be formed from a relatively flexible material. The properties of that flexible material may be such that it may only be deformed in the reconfiguration process in a way in which the minimum bend radius of the fibre is not exceeded. The receiving surface may, for example, have sufficient stiffness or rigidity to prevent the minimum bend radius of the fibre being exceeded. In this example, the material properties of the receiving surface act as a restriction means.

The hinges between the plurality of rigid regions may, for example, be weakened areas provided between adjacent rigid regions, or may take the form of living hinges, or may, for example, take the form of discrete mechanical hinges or flexible plastics fold lines provided between adjacent relatively rigid regions.

The receiving surface may comprise three relatively rigid regions and two hinged regions provided between the adjacent rigid regions.

The relatively rigid regions may be shaped so that, when in the closed position they define a substantially hollow enclosure of substantially rectangular cross section.

The restriction means act to restrict the movement of the receiving surface and prevent said receiving surface from being reconfigured to an arrangement in which the minimum bend radius of the loop of optical fibre is exceeded. As the receiving surface is reconfigured to the closed position, said restriction means may abut each other to prevent further relative movement of various portions of the receiving surface with respect to one another. In the fully closed configuration, each restriction means may abut or engage with another restriction means.

The restriction means may take the form of one of more upstanding elements provided on the receiving surface. Said upstanding elements may be provided at the edge of the receiving surface. Additionally or alternatively said upstanding elements may be provided within the periphery of the receiving surface. The upstanding elements may comprise a lip extending along at least part of one or more edges of the receiving surface.

The passive optical component organiser may further comprise means for receiving and securing a strain relief device with respect to the receiving surface.

Provision of a strain relief device receiving and securing area within the optical component organiser allows a strain relief device to be assembled substantially separately to the optical component organiser itself. Typically such strain relief devices are particularly small and separate assembly can result in quicker and/or more reliable strain relief.

The passive optical component organiser may further comprise a strain relief device to be received within the receiving means. Said strain relief device may be a mechanical strain relief device, for example, a strain relief device in which fibres are crimped, or otherwise mechanically engaged or gripped. Alternatively said strain relief device may be a device in which the strain is relieved by the potting process. In that process, the fibres are substantially surrounded and retained in a strain relief device by a volume of cured adhesive. In the case where the strain is relieved by the potting technique, assembly of the strain relief device separately to the optical component organiser may allow for the adhesive potting compounds to be inserted or injected around fibres housed in the strain relief device from a number of directions, thereby ensuring that said potting is particularly effective as a means of strain relieving.

Relieving the strain on fibres within the component organiser ensures that forces applied to a fibre external to the organiser are not directly transferred to the loop of fibre within the component organiser. Disturbing the loop of fibre housed within the optical component organiser can result in loss of optical quality in a transmitted signal and/or damage to the fibres housed therein.

The passive optical component organiser may further comprise a fibre input port and a fibre output port. When the receiving surface is in the closed position the input and output ports may be substantially aligned along the longitudinal axis of the component organiser.

Alignment of input and output points when the receiving surface is in the closed position allows for further optimisation of the dimensions of the component organiser. Furthermore, alignment of input and output ports may allow for improved identification and traceability of fibres entering and exiting such an optical component organiser.

The fibre input port may be a fibre adaptor. The fibre output port may be a fibre adaptor.

It will be understood that a simple optical connection can typically be made using a fibre adaptor and a fibre connector, those two parts co-operating mechanically in a manner similar to an electrical socket and plug respectively.

Use of a fibre adaptor as an input or output port allows a non-technical user to make an optical connection to a fibre housed within the component organiser. Furthermore, provision of a fibre connector on the fibre input port allows for ease of testing of the optical system surrounding the optical component organiser.

The optical component organiser may further comprise a housing for receiving a passive optical component. Said housing may also act to secure the passive optical component with respect to the receiving surface. Said housing may be located on the receiving surface. Said housing may be provided in a central region of the receiving surface. Alternatively, said housing may be provided in a region of an edge of the receiving surface.

The optical component organiser may itself be placed in a protective casing. Said protective casing may act to hold the component organiser in the closed configuration.

The present invention further provides a method of organising optical components, comprising the steps of providing a reconfigurable passive optical component organiser, that component organiser comprising a receiving surface and restriction means, configuring said receiving surface to be an open position in which the receiving position is substantially planar and in which a loop of optical fibre may be retained, and reconfiguring said receiving surface to be in a closed position in which said receiving surface is non-planar and substantially encloses said loop of fibre, the restriction means operating in the closed position to prevent the receiving surface from being reconfigured to an arrangement in which the minimum bend radius of the loop of optical fibre is exceeded.

The method according to the present invention may further include steps corresponding to the features set out above in relation to the passive optical component organiser.

Further particular and preferred aspects of the present invention are set out in the accompanying independent and dependent claims. Features of the dependent claims may be combined with features of the independent claims as appropriate, and in combinations other than those explicitly set out in the claims.

### BRIEF DESCRIPTION OF THE DRAWINGS

Embodiments of the present invention will now be described, with reference to the accompanying drawings, in which:

FIG. 1 illustrates a cable distribution arrangement;

FIG. 2 illustrates an arrangement of an optical cable;

FIG. 3 illustrates an arrangement of a multiple dwelling unit building distributor according to an embodiment;

FIG. 4 illustrates a splitter organiser in accordance with a first embodiment of the present invention in an open position;

FIG. 5 illustrates the splitter organiser of FIG. 4 including a strain relief device;

FIG. 6 illustrates an exploded perspective view of the strain relief device shown in FIG. 5;

FIG. 7 illustrates the assembled strain relief device of FIG. 6;

FIG. 8 illustrates the splitter organiser of FIG. 4 in a closed position;

FIG. 9a illustrates the splitter organiser of FIG. 8 partially inserted into a housing;

FIG. 9b illustrates the splitter organiser of FIG. 8 fully inserted into a housing;

FIG. 10a illustrates a splitter organiser in accordance with a second embodiment of the present invention in an open position;

FIG. 10b illustrates the splitter organiser of FIG. 10a in a semi-closed position;

FIG. 10c illustrates the splitter organiser of FIG. 10a in a fully-closed position; and

FIG. 11 illustrates the splitter organiser of FIG. 10a including an optical fibre adapter.

### DESCRIPTION OF THE EMBODIMENTS

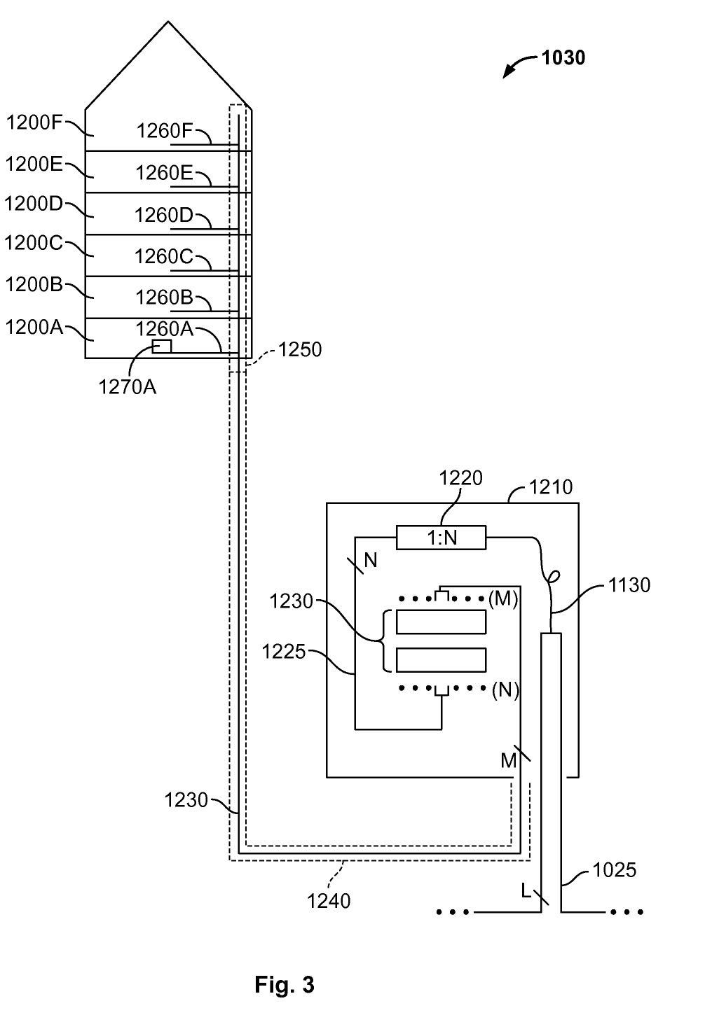

FIG. 1 illustrates a cable distribution arrangement 1000. A central office 1010 associated with a service provider is coupled with a distribution point 1020 by an outside service provider cable 1015. Distribution point 1020 may be coupled with further distributions points (not shown) using outside service provider distribution cables 1023 and 1027. The distribution point 1020 couples with one or more multiple dwelling units 1030, 1040, 1050, using an outside service provider distribution cable 1025. The outside service provider distribution cable 1025 loops through each multiple dwelling unit 1030, 1040, 1050 in turn. The outside service provider distribution cable 1025 may also loop through further multiple dwelling units (not shown). In this way, it can be seen that the service provider couples via an optical network with the multiple dwelling units 1030, 1040, 1050. Details of how the outside service provider distribution cable 1025 is then utilised within the multiple dwelling units 1030, 1040, 1050 are described below, with reference to FIG. 3.

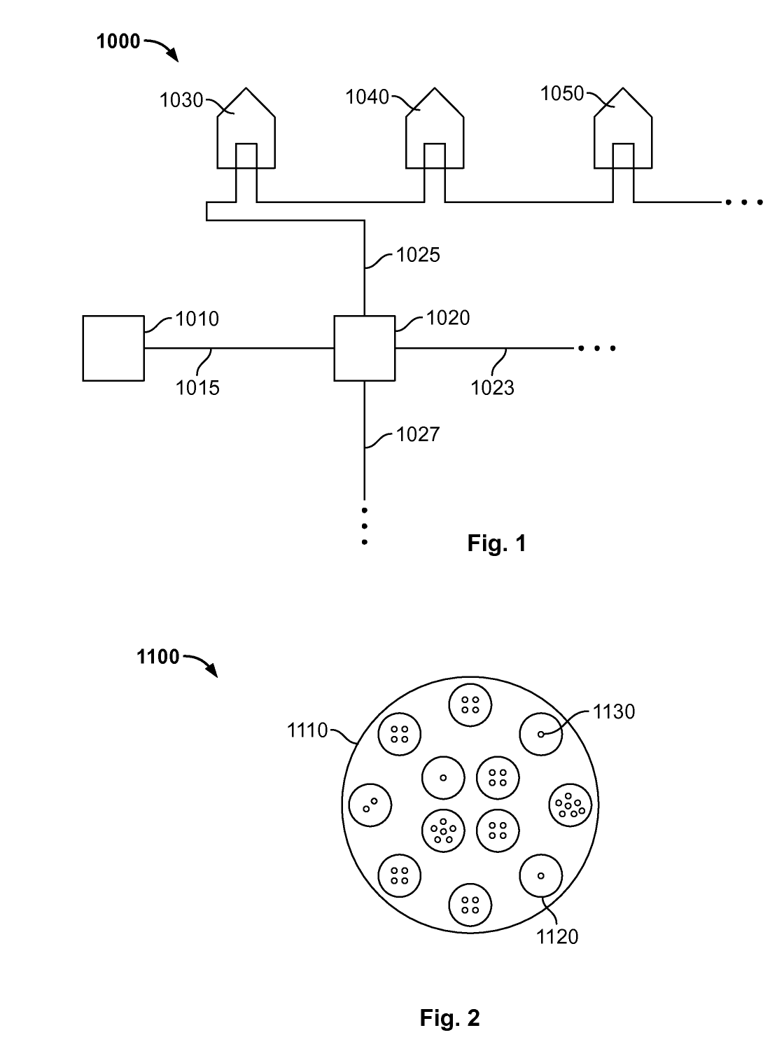

FIG. 2 illustrates a typical arrangement of an optical cable 1100, such as would be utilised for the outside service provider cable 1015, the outside service provider distribution cables 1023, 1025, 1027, or for cables utilised within the multiple dwelling units 1030, 1040, 1050.

The cable 1100 comprises an outer jacket 1110 which provides for appropriate environmental protection of the cable 1100. Disposed within the cable jacket 1110 are a plurality of tubes 1120. Within the tubes 1120 are provided one or more individual fibres 1130. Typically 16 or 32 individual fibres 1130 may be provided within a single tube 1120. Also a braided Kevlar (registered trade mark) strand (not shown) may be provided within cable 1100 which may be mechanically coupled with a pulling tool to assist in routing the cable.

FIG. 3 illustrates an arrangement of a multiple dwelling unit building distributor 1210 for dwelling unit 1030 according to one embodiment. In the example shown in FIG. 3, the multiple dwelling unit 1030 comprises a single dwelling unit 1200A-1200F on each floor. However, it will be appreciated that more than one dwelling unit may be provided on each floor of the building. The other multiple dwelling units 1040, 1050 will generally have a similar general layout, although the number of floors and the number of dwelling units on each floor may vary from multiple dwelling unit to multiple dwelling unit.

The multiple dwelling unit building distributor 1210 receives the outside surface provider distribution cable 1025. One or more fibres 1130 from the outside service provider distribution cable 1025 are pulled from the outside service provider distribution cable 1025 and typically coupled with a splitter 1220. It will be appreciated that more than one splitter unit 1220 may be provided and that more than one fibre 1130 may be extracted from the outside service provider distribution cable 1025, according to the needs of the multiple dwelling unit 1030. The splitter 1220 takes a single fibre 1130 and couples this fibre, typically using splicing techniques, with a plurality N of pigtail cables 1225. The plurality of pigtail cables 1225 are provided to a patching arrangement 1230 which enables the plurality of pigtails 1225 to be selectively coupled with a riser cable 1230 comprising a plurality M of fibres which leaves the multiple dwelling unit building distributor 1210.

The riser cable 1230 is routed through a building region 1240 to a riser 1250. The building region 1240 may be, for example, a basement area of the multiple dwelling unit 1030. The riser cable 1230 may be surface mounted in the building region 1240.

The riser 1250 will typically be a service conduit within the multiple dwelling unit 1030 extending from the basement to the under-roof region of the building. The riser 1250 will therefore extend between the floors of the multiple dwelling unit 1030.

Within each dwelling unit 1200A-1200F, one or more fibres 1260A-1260F may be pulled from the riser cable 1230 in order to provide connectivity within the individual dwelling units 1200A-1200F. User equipment 1270A may then couple with the associated fibres 1260, as required.

It will be appreciated that arrangement enables user equipment within individual dwelling units to be coupled via the optical network with the service providers. Also, the presence of the patch arrangement 1230 within the multiple dwelling unit building distributor 1210 enables connectivity with different service providers to be achieved.

FIG. 4 illustrates a splitter organiser 1 in accordance with the present invention and suitable for use in a splitter unit 1220 of the building distributor 1210. A fibre 1130 (not shown in FIG. 4) from the outside service provider distribution cable 1025 is directed into the splitter unit 1220 and enters the splitter organiser 1. That fibre 1120 may be spliced or otherwise optically coupled to a splitter 10 located within the splitter organiser. The splitter 10 acts to couple the fibre entering the splitter to a plurality of pigtails 1225 (not shown in FIG. 4). Each of those pigtails contains a fibre.

The splitter organiser of FIG. 4 has three main portions: a base (or central) region 20 and two side regions 21, 22. Together these three portions form, when the splitter organiser is in the open position, a substantially flat receiving surface, on which the splitter 10 and fibres entering and exiting said splitter may be conveniently arranged and worked upon. Side portions 21, 22 are hingedly attached to the central portion 20 along fold lines C and D. In the embodiment shown, the splitter organiser is constructed from a relatively flexible material, and the fold lines are formed by weakening the material of the splitter organiser 1 along those lines. In the embodiment shown, that weakening has been achieved by making that portion of the material thinner

The side portions 21,22 include upstanding shaped side walls 31,32. Those upstanding side walls differ in shape from end A (31a, 32a) to end B (31b, 32b) of the organiser, but both act to restrict the possible range of movement of the side portions with respect to the central portion. The central portion also includes a shaped end wall 30a. The end wall 30a co-operate with side walls 31a, 32a to restrict relative position so the central and side portions.

The splitter 10 is held in place on the central portion 20 by a series of holding elements 28.

Provided in the region of end B of the splitter organiser are a series of retaining elements 29 which engage with a strain relief device 40 not shown in FIG. 4. When retained by the elements 29, the strain relief device is arranged to secure the plurality of pigtails 1225 in place relative to the splitter organiser, and ensure that forces applied to the pigtails 1225 are not transferred to the fibres housed in the splitter organiser.

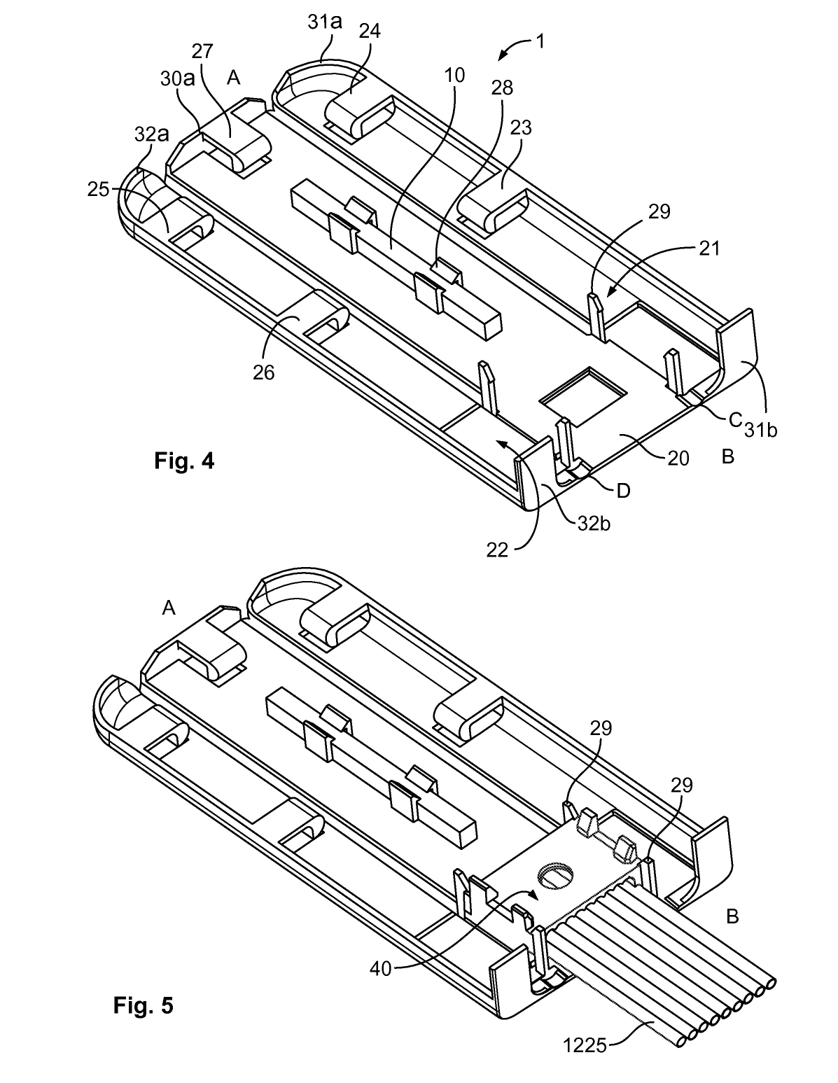

The strain relief device is shown in place on splitter organiser 1 in FIG. 5.

In use, the fibre 1130 enters the splitter organiser 1 at end A and is directed towards the splitter 10. On exiting the splitter 10, to maintain optical performance, the fibres performs a full loop within the splitter organiser and are then directed towards end B of the splitter organiser. The loop of fibres is held in place within the organiser 1 by a series of retaining tabs 23,24,25,26 formed as part of the side portions 21,22. The loop is also held by a similar retaining tab 27 provided on the central portion 20. Those tabs all act together to secure and position the loop of fibres within the organiser. The tabs have hooked ends and hold said loop of fibres in substantially one plane on the receiving surface of the splitter organiser.

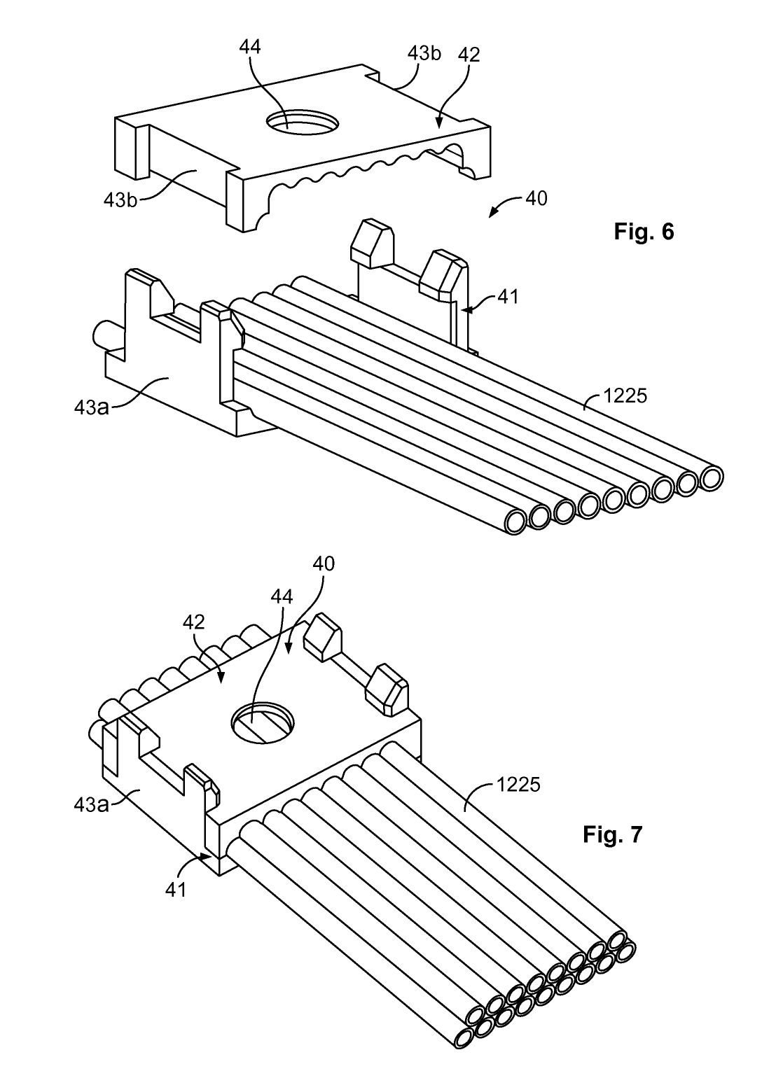

FIGS. 6 and 7 show the strain relief device 40 in more detail. The strain relief device 40 is formed in two halves: a base portion 41 and a lid portion 42. Layers of pigtails 1225 can be arranged within the base portion. After layers of pigtails 1225 have been arranged within the base portion 41, the lid 42 is placed on top of the base portion 4. Appropriately shaped projections 43a provided on the base portion 41 engage in a “snap-fit” manner with appropriately shaped recesses 43b provided on the lid portion 42. FIG. 7 shows two layers of pigtails 1225 arranged in a closed strain relief device 40.

Once assembled, potting compound may be injected into the layers of pigtails through an opening 44 provided in the lid. A further opening for injection of potting compound may be provided in the base but cannot be seen in FIG. 6 or 7. Once the strain relief device and pigtails have been assembled and potting compound has been injected into opening 44, the potting compound is left to cure. Cured potting compound secures the pigtails with respect to one another and the strain relief device.

Once assembled, the strain relief device 40 is inserted into the splitter organiser 1 as shown in FIG. 5. The series of retaining elements 29 provided on the central portion of the splitter organiser include hook-end portions which engage over the lid of the strain relief device 40 in a “snap-fit” manner.

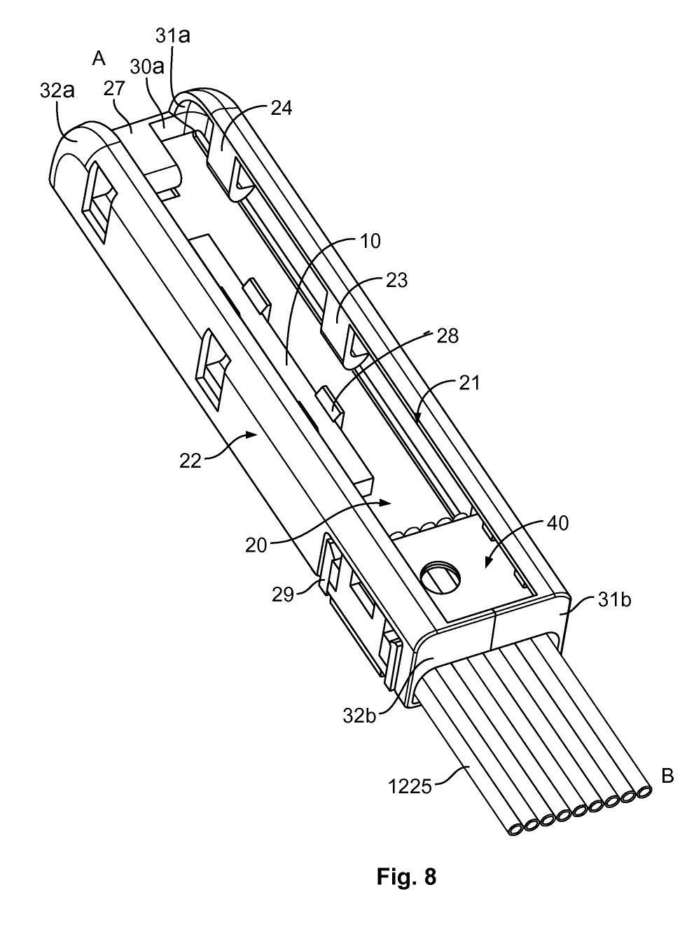

FIG. 8 shows the splitter organiser of FIG. 4 in the closed position.

It will be appreciated that retaining tabs 23,24,27,25 and 26 provided on the base portion 20 and the two side portions 21,22 act to hold the fibre loop (not shown in FIG. 4 or 8) in place on the receiving surface of the splitter organiser. The retaining tabs also hold the loop in place as the splitter organiser is moved between the open configuration shown in FIG. 4 and the closed position shown in FIG. 8.

The curves (in three dimensions) induced in the loop of fibre by the movement of the organiser from the open position to the closed position are controlled by the relative shapes of the side walls, 31a, 31b, 32a, 32b, and the shaped end wall 30a. It will be understood from the figures that these walls are shaped so that they abut as the splitter organiser is moved towards the closed position. In particular, it can be seen that in the closed position where the two side portions have been folded towards each other along fold lines C and D, the walls 31b and 32b at end B prevent further movement inwards and the walls 31a, 32a and 30a prevent further movement of the side portions towards the central portion.

The relative dimensions of the walls and the three portions forming the organiser, together with the appropriate shaping of the restriction elements 31b, 32b, 31a, 32a and 30a are chosen with reference to the particular type of fibre to be housed within the organiser. The dimensions ensure that when inducing a bend in the loops of fibre, the minimum bend radius of that particular fibre type is not exceeded.

Once in the closed position, the splitter organiser is held in the closed position by insertion to a substantially tubular housing 50.

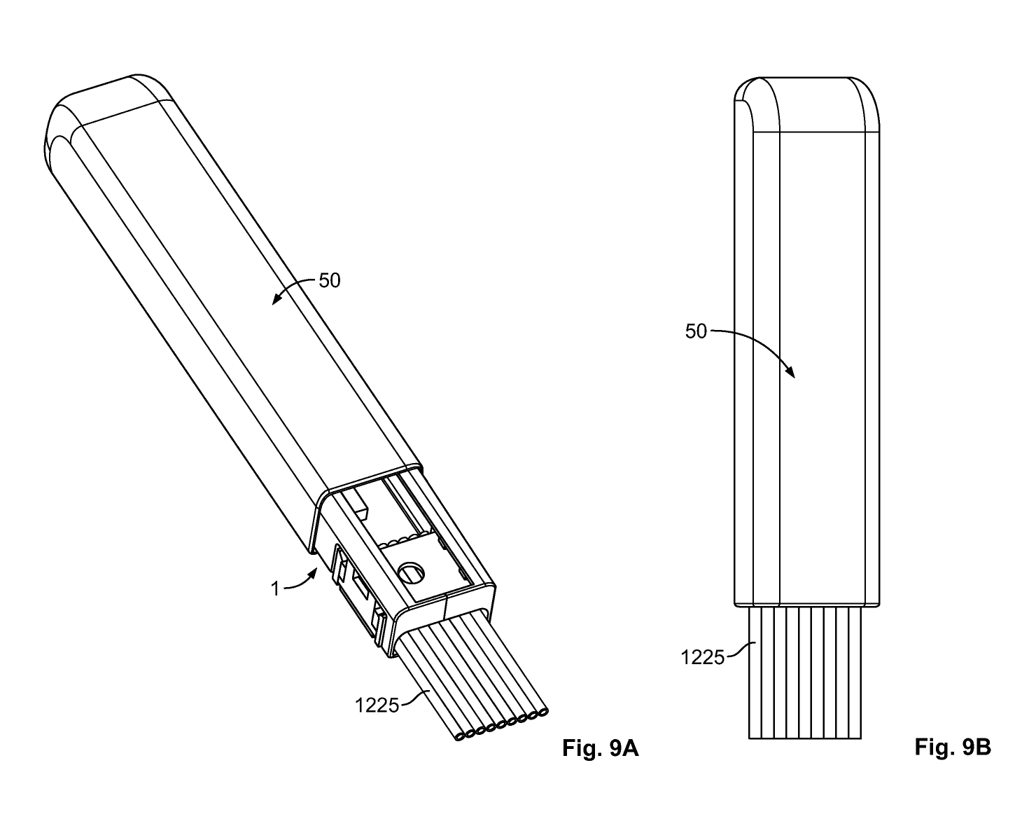

FIG. 9a shows the splitter organiser of FIG. 4 partially inserted within a housing 50. FIG. 9b shows the splitter organiser of FIGS. 4 and 8 fully inserted into a housing 50. It will be appreciated that the housing 50 provides protection to the splitter 10 and the connection between a single fibre and those entering pigtails 1225. Such housing provides protection from dust, ingress of water and damage.

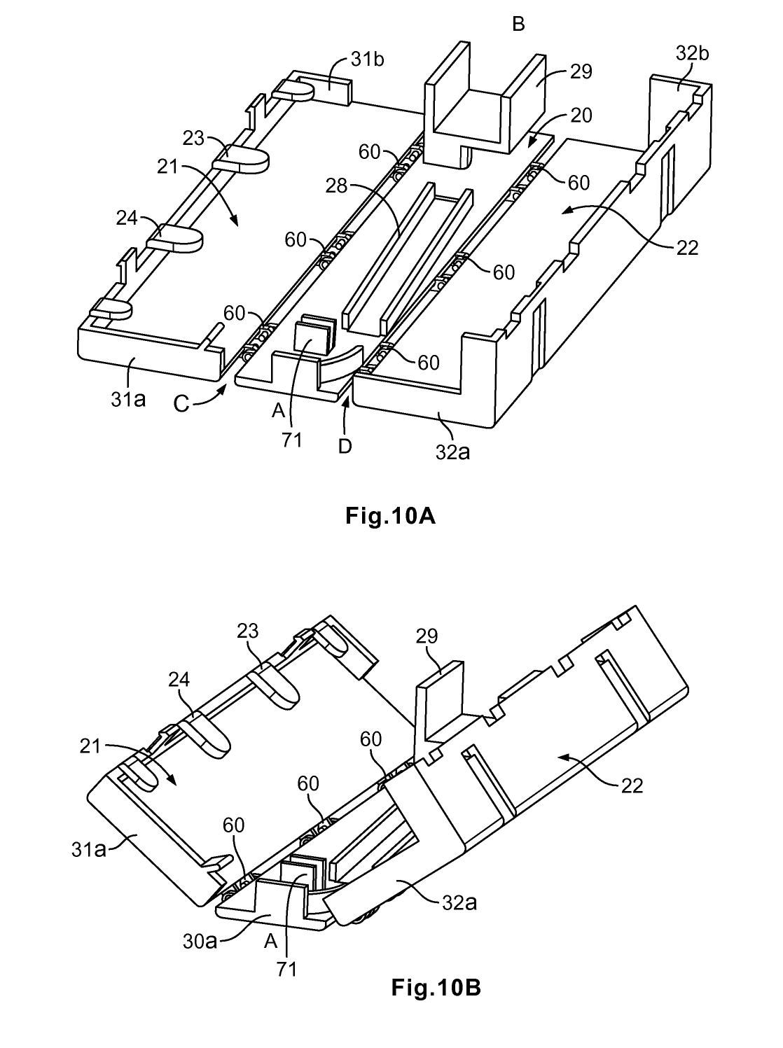

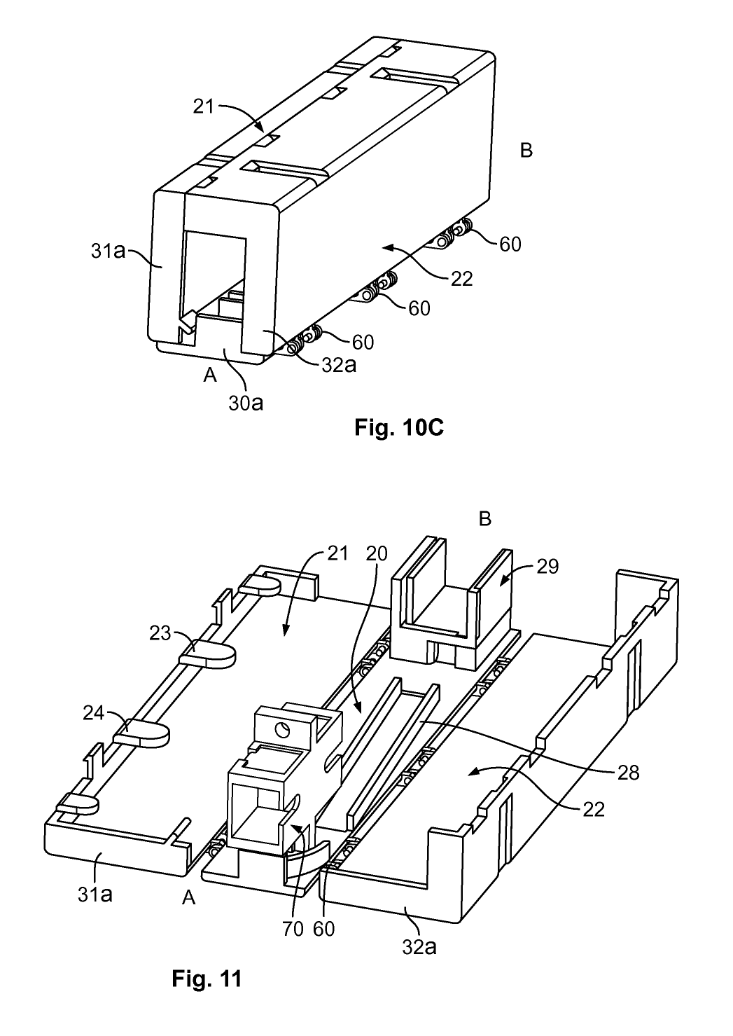

FIGS. 10a, 10b and 10c show a second embodiment of a splitter organiser in accordance with the present invention. Where appropriate, the same reference numerals have been used to identify like features.

The splitter organiser of FIGS. 10a to 10c is formed from three rigid portions. Those rigid portions are hingedly connected. The rigid central portion is connected to the rigid side portions by hinges 60. In this embodiment the central portion 20 also includes a socket 71 adapted to receive an optical adapter 70 (shown in FIG. 11).

It will be appreciated that optical adapters 70 is well known in the art and an arrangement which includes an optical adaptor 70 allows for easy connection by an unskilled user between a fibre 1130 including an optical connector and the optical adaptor.

Provision of the adaptor connector in the input region of the splitter organiser also allows for simpler testing of the optical network including the splitter.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A reconfigurable passive optical component organiser comprising: a receiving surface and restriction means, said receiving surface comprising a plurality of relatively rigid regions hinged together and being reconfigurable between an open position in which the receiving surface is configured to be substantially planar and retain a loop of optical fibre, and a closed position in which said receiving surface is non-planar and substantially encloses said loop of fibre, the restriction means acting to prevent the reconfiguration of the receiving surface to the closed position from bending the loop of fibre beyond the minimum bend radius of the loop of optical fibre,

2. A passive optical component organiser according to claim 1, wherein the relatively rigid regions are hinged together by discrete mechanical hinges or by flexible plastics fold lines.

3. A passive optical component organiser according to claim 1, wherein the receiving surface comprises three relatively rigid regions and two hinge lines provided between the adjacent relatively rigid regions.

4. A passive optical component organiser according to claim 1, wherein the said rigid regions are shaped so that, when in closed position, they define a substantially hollow enclosure of substantially rectangular cross section.

5. A passive optical component organiser according to claim 1, wherein the restriction means take the form of one or more upstanding elements provided on the receiving surface.

6. A passive optical component organiser according to claim 1, further comprising means for receiving and securing a strain relief device with respect to the receiving surface.

7. A passive optical component organiser according to claim 6, further comprising a strain relief device.

8. A passive optical component organiser according to claim 1, further comprising a fibre input port and a fibre output port, in which when the receiving surface is in the closed position, the input and output ports are substantially aligned along the longitudinal axis of the component organiser.

9. A passive optical component organiser according to claim 1, further comprising a fibre input port and a fibre output port, in which the fibre input port is an optical adaptor.

10. A passive optical component organiser according to claim 1, further comprising a housing for receiving a passive optical component.

11. A passive optical component organiser according to claim 1, in which the optical component is a splitter.

12. A method of organising optical components, comprising the steps of providing a reconfigurable passive optical component organiser, that component organiser comprising a receiving surface and restriction means, configuring said receiving surface to be in an open position in which the receiving surface is substantially planar and in which a loop of optical fibre may be retained, and reconfiguring said receiving surface to be in a closed position in which said receiving surface is non-planar and substantially encloses said loop of fibre, the restriction means operating in the closed position to prevent the receiving surface from being configured to an arrangement in which the minimum bend radius of the loop of optical fibre is exceeded.
